(19) United States
(12) Patent Application Publication
(10) Pub. No.: US 2010/0097525 A1
(43) Pub. Date: Apr. 22, 2010

(54) DISPLAY DEVICE AND DISPLAY METHOD

(75) Inventor: Atsushi Mino, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 12/530,990

(22) PCT Filed: Mar. 11, 2008
(86) PCT No.: PCT/JP2008/054353

§ 371 Date: Sep. 11, 2009

(30) Foreign Application Priority Data
Mar. 15, 2007 (JP) 2007-066359

(51) Int. Cl. H04N 5/445

(52) U.S. Cl. 348/564; 348/E05.099

(57) ABSTRACT

Provided are a cheap display device and a display method that are capable of preventing loss of high-frequency component during generation of a video signal from a source signal while at the same time securing continuity of pixel data.

The display device includes a display portion 7 capable of displaying distinct videos on a common screen in a plurality of viewing directions and a video signal generating portion 300 for generating video signals by carrying out compression processing of video source signals for the viewing directions at predetermined compression rates. The video signal generating portion 300 generates new color components by using color components of a plurality of adjacent pixels aligned in a predetermined direction among pixels corresponding to the video source signals, and generates each of the video signals on the basis of a new pixel composed of the generated color components.

This application is the U.S. national phase of international application PCT/JP2008/054353, filed on Mar. 11, 2008, which designated the U.S. and claims priority to JP Application No. 2007-066359, filed on Mar. 15, 2007. The entire contents of these applications are incorporated herein by reference.

### TECHNICAL FIELD

The present invention relates to a display device including a display portion capable of displaying distinct videos on a common screen in a plurality of viewing directions and a video signal generating portion for generating video signals by carrying out compression processing of image data from video source signals for the viewing directions at predetermined compression rates.

### BACKGROUND ART

Main developments of displays have thus far been drawn to optimization to enable a viewer to see a display from any directions with equally good image quality or to enable a plurality of viewers to obtain the same information simultaneously.

However, there are many applications where different videos are desirably displayed so that individual viewers can visually recognize different pieces of information from videos displayed on a common display.

For example, there are cases where through a display mounted in a vehicle, a driver wishes to see a navigation video while a person next to the driver wishes to see a movie recorded on a DVD or the like. In such cases, mounting two displays requires a large mounting space, and further, increases the cost.

Under such circumstances, patent document 1 and patent document 2 each disclose a display device that displays two different videos simultaneously on a single liquid crystal display so that mutually different videos can be seen from, for example, the driver's seat and the passenger seat.

These display devices are such display devices that even though there is only a single display screen, different videos are simultaneously displayed thereon so that each video can be visually recognized when the screen is viewed from a corresponding one of different viewing directions.

The above-described display devices need to drive a different pixel group for every video source and thus generate a video signal by compression-processing 1 frame of original pixel data based on a video source signal in a predetermined direction so that 1 frame of pixel data based on the generated video signal drives the pixel group.

For example, in the case of vehicle-dedicated TFT liquid crystal display devices mainly of 800×480 dots of pixels, a video source signal corresponding to 800×480 dots of pixels per 1 frame is compressed to ½ its size in the horizontal direction, thus generating a video signal corresponding to 400×480 dots of pixels per 1 frame.

However, when, during generation of the video signal, the original pixel data constituting the video source signal is subjected only to decimation processing in a predetermined direction, the information of the decimated portion of the original pixel data might be lost, resulting in not only loss of a high-frequency component of the 1-frame image but also a lack of continuity between adjacent pieces of pixel data.

Thus, such a problem results that the video shown on the display on the basis of such video signal is extremely hard to see.

In view of this, patent document 3 discloses a dual-view display device capable of displaying two kinds of videos simultaneously on a common screen, and proposes, in order to prevent loss of the high-frequency component during generation of the video signal from the video source signal, a signal processing device that carries out, using a low-pass filter, smoothing processing of any datum of original pixel data aligned in a predetermined direction and an original pixel datum adjacent to the foregoing original pixel datum, and carries out decimation processing of the smoothing-processed pixel data on the basis of a compression rate.

[Patent document 1] Japanese Unexamined Patent Publication No. 6-186526.
[Patent document 2] Japanese Unexamined Patent Publication No. 2000-137443.
[Patent document 3] Japanese Unexamined Patent Publication No. 2006-154756.

### DISCLOSURE OF THE INVENTION

### Problems that the Invention is to Solve

However, the conventional technique described in patent document 3 necessitates a complicated filter circuit that combines together a multiplication circuit for multiplying a plurality of adjacent pixels by predetermined filter coefficients, an addition circuit for adding the multiplied values to each other, and a division circuit for dividing the added value by the sum of the filter coefficients. This increases the scale of the circuit, which in turn poses problems including an increased member-dedicated space on a substrate and increased cost.

In view of the foregoing problems, it is an object of the present invention to provide a cheap display device and a display method that are capable of preventing loss of high-frequency component during generation of a video signal from a source signal while at the same time securing continuity of pixel data.

### Means of Solving the Problems

In order to accomplish the above object, a feature configuration of a display device according to the present invention is as follows. The display device includes a display portion capable of displaying distinct videos on a common screen in a plurality of viewing directions and a video signal generating portion for generating video signals by carrying out compression processing of video source signals for the viewing directions at predetermined compression rates, wherein the video signal generating portion generates new color components by using color components of a plurality of adjacent pixels aligned in a predetermined direction among pixels corresponding to the video source signals, and generates each of the video signals on the basis of a new pixel composed of the generated color components.

With this configuration, new color components are generated only by providing a simple circuit that selectively extracts a color component from the color components of each of the plurality of adjacent pixels that correspond to a video source signal. The resulting pixel composed of the newly extracted color components has a high-frequency component incorporated by at least one of the constituent components, and pixel continuity is secured at the same time.

### EFFECTS OF THE INVENTION

As has been described hereinbefore, the present invention has made it possible to provide a cheap display device and a display method that are capable of preventing loss of high-frequency component during generation of a video signal from a source signal while at the same time securing continuity of pixel data.

### BRIEF DESCRIPTION OF THE DRAWINGS

FIG. 1 is a schematic diagram of a display device according to the present invention.

FIG. 2 is a perspective view of a vehicle for illustrating an example in which the display device is applied to the vehicle.

FIG. 3 is a schematic cross-sectional view of a display portion.

FIG. 4 is a schematic frontal view of the structure of a display panel.

FIG. 5 is a circuit diagram schematically illustrating a TFT substrate.

FIG. 6 is a block diagram schematically illustrating the display device according to the present invention.

FIG. 7 is a block diagram schematically illustrating an image outputting portion.

FIG. 8 is a block diagram schematically illustrating a control portion.

FIG. 9 is a block diagram schematically illustrating a memory.

FIG. 10 is a diagram illustrating a procedure for generation of video signals from dual video signals to be displayed on the display portion.

FIG. 11 is a configuration block diagram of a video signal generating portion.

FIG. 12A is a diagram illustrating a generation operation of new color components by a first video signal generating portion; and FIG. 12B is another diagram illustrating the generation operation of new color components by the first video signal generating portion.

FIG. 13 is a diagram illustrating a generation operation of new color components by a second video signal generating portion.

FIG. 14 is another diagram illustrating the generation operation of new color components by the second video signal generating portion.

FIG. 15A is a diagram illustrating a video image that is based on a video source signal of a pre-compressed original image; FIG. 15B is a diagram illustrating a video image that is based on a video signal compressively generated by carrying out decimation processing of a video source signal of the original image; FIG. 15C is a diagram illustrating a video image that is based on a video signal compressively generated from the video source signal of the original image by the first video signal generating portion; and FIG. 15D is a diagram illustrating an image that is based on a video signal compressively generated from the video source signal of the original image by the second video signal generating portion.

FIG. 16A is a diagram illustrating a video image that is based on a video source signal of a pre-compressed original image; FIG. 16B is a diagram illustrating a video image that is based on a video signal compressively generated by carrying out decimation processing of a video source signal of the original image; FIG. 16C is a diagram illustrating a video image that is based on a video signal compressively generated from the video source signal of the original image by the first video signal generating portion; and FIG. 16D is a diagram illustrating a video image that is based on a video signal compressively generated from the video source signal of the original image by the second video signal generating portion.

FIG. 17 is a flowchart for describing a video signal generating operation by the video signal generating portion.

### DESCRIPTION OF REFERENCE NUMERAL

1: first video source, 2: second video source, 3: first image data, 4: second image data, 5: display control device, 6: display data, 7: display portion, 8: first display image, 9: second display image, 10: viewer, 11: viewer, 12: passenger seat, 13: driver's seat, 14: windshield, 15: operation portion, 16: speaker, 100: liquid crystal panel, 101: back light, 102: polarization plate, 103: polarization plate, 104: TFT substrate, 105: liquid crystal layer, 106: color filter substrate, 107: glass substrate, 108: parallax barrier, 109: pixel for left side (passenger seat side) display, 110: pixel for right side (driver's seat side) display, 111: display panel driving portion, 112: scan line driving circuit, 113: data line driving circuit, 114: TFT element, 115-118: data lines, 119-121: scan lines, 122: pixel electrode, 123: sub-pixel, 124: touch panel, 200: control portion, 201: CD/MD playback portion, 202: radio receiving portion, 203: TV receiving portion, 204: DVD playback portion, 205: HD (Hard Disk) playback portion, 206: navigation portion, 207: partition circuit, 208: first image adjusting circuit, 209: second image adjusting circuit, 210: sound adjusting circuit, 211: image outputting portion, 212: VICS information receiving portion, 213: GPS information receiving portion, 214: selector, 215: operation portion, 216: remote controller transmitting/receiving portion, 217: remote controller, 218: memory, 219: external sound/video inputting portion, 220: camera, 221: brightness detecting portion, 222: occupant detecting portion, 223: rear display portion, 224: ETC on-board device, 225: communication unit, 226: first writing circuit, 227: second writing circuit, 228: VRAM (Video RAM), 229: interface, 230: CPU, 231: storage portion, 232: data storage portion, 233: first screen RAM, 234: second screen RAM, 235: image quality setting information storage portion, 236: environmental adjusting value holding portion, 300: video signal generating portion, 301: first video signal generating portion, 302: second video signal generating portion, 310: switching portion.

### BEST MODE FOR CARRYING OUT THE INVENTION

The following describes basic embodiments of the display device according to the present invention by referring to the drawings. It should be noted that the present invention will not be limited in technical scope by the following embodiments but by the appended claims and equivalents thereof.

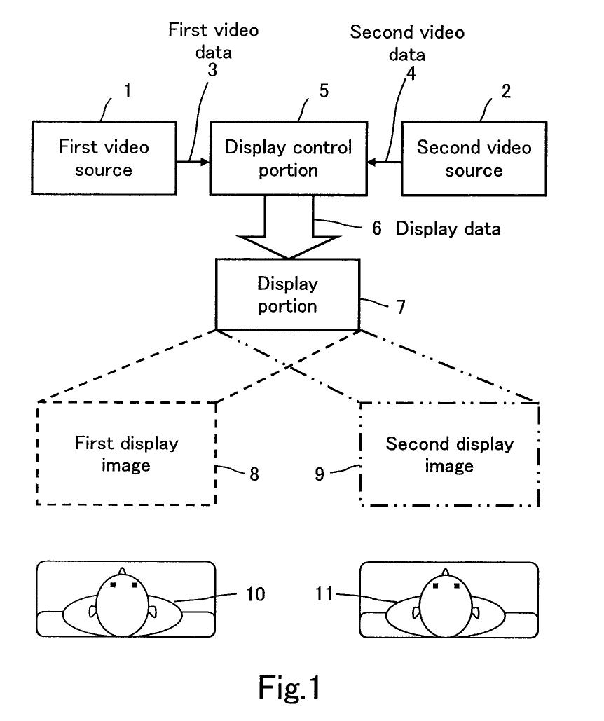

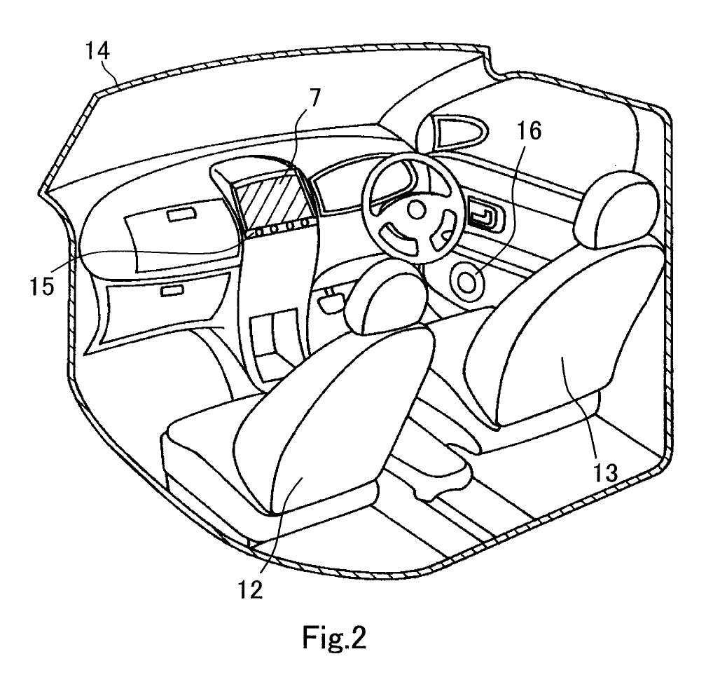

FIG. 1 is a schematic diagram of a dual view display device according to the present invention (hereinafter referred to as “display device”). In the figure, reference numeral 1 denotes a first video source, 2 denotes a second video source, 3 denotes first video data from the first video source, 4 denotes second video data from the second video source, 5 denotes a display control portion, 6 denotes display data, 7 denotes a display portion (e.g., a liquid crystal panel), 8 denotes a first display image based on the first video source 1, 9 denotes a second display image based on the second video source 2, 10 denotes a viewer (user) located to the left of the display portion 7, and 11 denotes a viewer (user) located to the right of the display portion 7.

The schematic diagram in FIG. 1 shows that different display images are visually recognizable depending on the positions of the viewers 10 and 11 relative to the display portion 7, in other words, depending on the viewing angles from the display portion 7.

That is, the figure schematically shows that the viewer 10 can see the first display image 8 and the viewer 11 can see the second display image 9 substantially simultaneously, and further that the display images 8 and 9 can be seen individually over the entire screen of the display portion 7.

In FIG. 1, the first video source 1 is, for example, a movie image from a DVD player or a received image of a television receiver, while the second video source 2 is, for example, a map or a route guiding image from a car navigation device.

The first video data 3 and the second video data 4 are supplied to the display control portion 5, which acts as the video signal generating portion according to the present invention, in order to process these data to be displayable substantially simultaneously on the display portion 7.

The display portion 7, to which the display data 6 is supplied from the display control portion 5, is composed of a liquid crystal panel or the like provided with parallax barriers, described later. Half the total pixels in the lateral direction of the display portion 7 are used to display the first display image 8 on the basis of the first video source 1, while the other half of the pixels are used to display the second display image 9 on the basis of the second video source 2.

To the viewer 10, which is located to the left of the display portion 7, only the pixels corresponding to the first display image 8 are visually recognizable, and the second display image 9 is shielded by the parallax barriers formed on the surface of the display portion 7 and substantially cannot be seen. To the viewer 11, which is located to the right of the display portion 7, only the pixels corresponding to the second display image 9 are visually recognizable, and the first display image 8 is shielded by the parallax barriers and substantially cannot be seen.

To the parallax barriers, configurations disclosed in, for example, Japanese Unexamined Patent Publication No. 10-123461 and Japanese Unexamined Patent Publication No. 11-84131 may be applied.

This configuration provides the users existing on the left and right of the display with mutually different pieces of video information and contents using only a single screen. It is of course possible that when the first and second video sources are the same, the right and left users can see the same image, as usual.

FIG. 2 is a perspective view of a vehicle for illustrating an example in which the display device according to the present invention is applied to the vehicle. In the figure, reference numeral 12 denotes a passenger seat, 13 denotes a driver's seat, 14 denotes a windshield, 15 denotes an operation portion, and 16 denotes a speaker.

The display portion 7 of the display device shown in FIG. 1 is located on an approximately central, dashboard portion between the driver's seat 13 and the passenger seat 12 and on in the manner shown in, for example, FIG. 2. Various kinds of operation to the display device are made using a touch panel integrally formed on the surface of the display portion 7 and the operation portion 15, or using an infrared or wireless remote controller. The speakers 16 are located on the doors of the vehicle and output voice or alarm sound associated with the display image.

The viewer 11 shown in FIG. 1 sits on the driver's seat 13 and the viewer 10 sits on the passenger seat 12. The image seen from a first viewing direction (driver's seat side) relative to the display portion 7 is an image of, for example, a map from a navigation device, and the image seen from a second viewing direction (passenger seat side), which can be seen substantially simultaneously with the image in the first viewing direction, is an image from a television receiver or a DVD movie image, for example.

Thus, the driver on the driver's seat 13 can receive help of car navigation during driving while at the same time the passenger on the passenger seat 12 can enjoy TV or DVD. In addition, the images are individually displayed using the entire screen of, for example, 7 inches, thereby eliminating the size reduction of screen encountered with conventional multi-window displays. That is, the driver and the passenger are presented with respectively optimum information or contents from a display that appears to be mutually independent, dedicated displays.

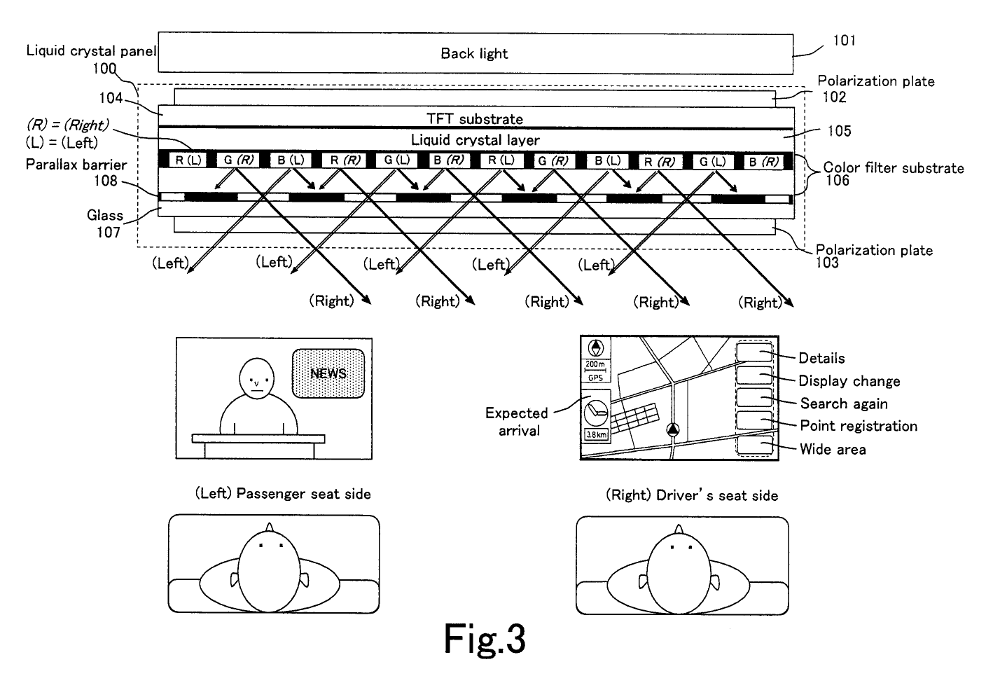

FIG. 3 is a schematic cross-sectional view of the display portion 7. In the figure, reference numeral 100 denotes a liquid crystal panel, 101 denotes a back light, 102 denotes a polarization plate located on the back light side of the liquid crystal panel, 103 denotes a polarization plate located on a front side of the liquid crystal panel in the light emitting direction, 104 denotes a TFT (Thin Film Transistor) substrate, 105 denotes a liquid crystal layer, 106 denotes a color filter substrate, 107 denotes a glass substrate, and 108 denotes a parallax barrier.

The liquid crystal panel 100 is configured to sandwich between the two polarization plates 102 and 103: a pair of substrates, which are the TFT substrate 104 and the color filter substrate 106, with the liquid crystal layer 105 sandwiched therebetween; the parallax barriers 108 located on the front side of the liquid crystal panel in the light emitting direction; and the glass substrate 107. The liquid crystal panel 100 is located at some distance from the back light 101. The liquid crystal panel 100 also includes pixels of the three primary colors R, G, and B.

The pixels of the liquid crystal panel 100 are display-controlled while being sorted out for left side (passenger seat side) display use and for right side (driver's seat side) display use. Display of the left side (passenger seat side) display pixels to the right side (driver's seat side) is shielded by the parallax barriers 108, so that the left side display pixels can be seen only from the left side (passenger seat side). Display of the right side (driver's seat side) display pixels to the left side (passenger seat side) is shielded by the parallax barriers 108, so that the right side display pixels can be seen only from the right side (driver's seat side). This enables the driver and the passenger to visually recognize mutually different videos.

Specifically, the driver visually recognizes map information of the navigation device while at the same time the passenger visually recognizes a DVD movie or the like. It is possible to implement a multi-view display device for displaying different images in a plurality of viewing directions such as three viewing directions, which will be possible by changing the configurations of the parallax barriers 108 and the pixels of the liquid crystal panel 100. The parallax barriers themselves may be electrically drivable crystal shutters or the like in order to obtain changeable viewing angles.

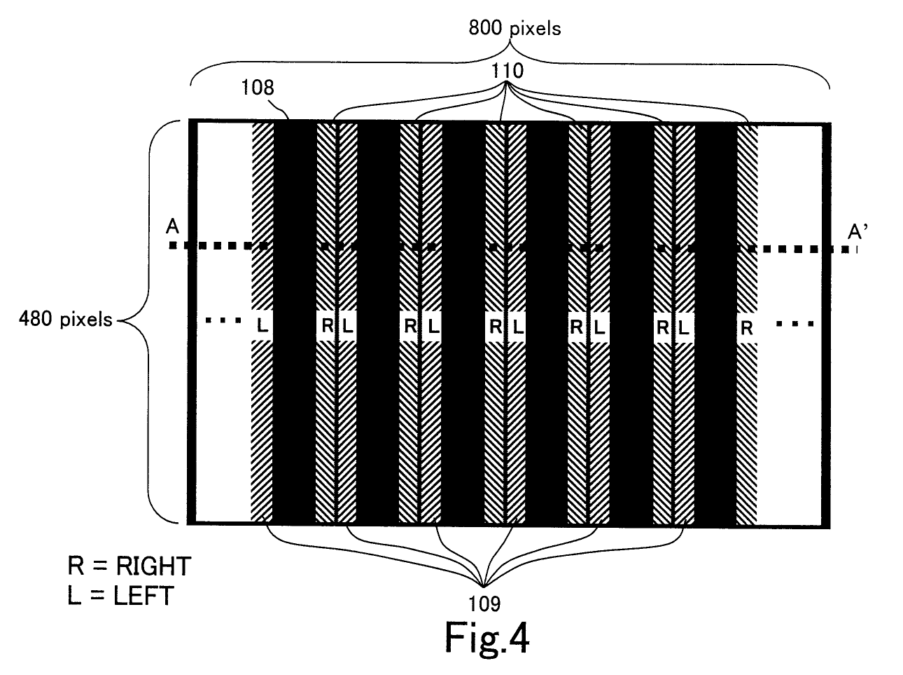

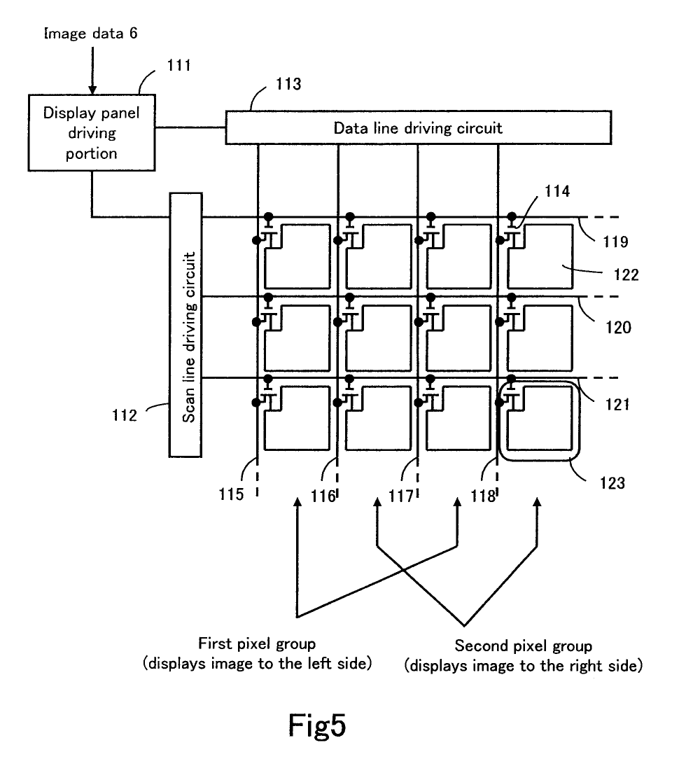

FIG. 4 is a schematic frontal view of the structure of the display portion 7, and FIG. 3 is an A-A′ cross-sectional view of the structure shown in FIG. 4. In FIG. 4, reference numeral 109 denotes pixels for left side (passenger seat side) display, and 110 denotes pixels for right side (driver's seat side) display. FIGS. 3 and 4 each illustrate a part of the liquid crystal panel 100 of, for example, 800 pixels aligned in the lateral direction and 480 pixels aligned in the vertical direction.

The pixels 109 for left side (passenger seat side) display and the pixels 110 for right side (driver's seat side) display are grouped in the vertical direction and aligned alternately. The parallax barriers 108 are arranged at predetermined intervals in the lateral direction and uniformly in the vertical direction. Thus, when the display panel is viewed from the left side, the parallax barriers 108 hide the right side pixels 110 to make the left side pixels 109 viewable. Likewise, when the display panel is viewed from the right side, the parallax barriers 108 hide the left side pixels 109 to make the right side pixels 110 viewable. When the display panel is viewed from around the front thereof, both left side pixels 109 and right side pixels 110 are seen, resulting in a substantially overlapping view of the left side display image and the right side display image.

Here the alternately arranged left side pixels 109 and right side pixels 110 shown in FIG. 4 each have one of the colors RGB as shown in FIG. 3, and each of the vertical direction groups may be composed of single-color pixels to constitute an R line, a G line, or a B line. Alternatively, each line may be composed of a mixture of the colors RGB.

In order for the display portion 7 to display different videos in two directions, namely, in the left side (passenger seat side) and right side (driver's seat side) directions, the 800×480 pixels per frame, which constitute the video source signal, may be compressed into 400×480 pixels per frame and these pixels may be aligned alternately in the horizontal direction, thereby making it possible to generate video signals corresponding the 800×480 pixels, which is the number of the pixels of the display portion 7.

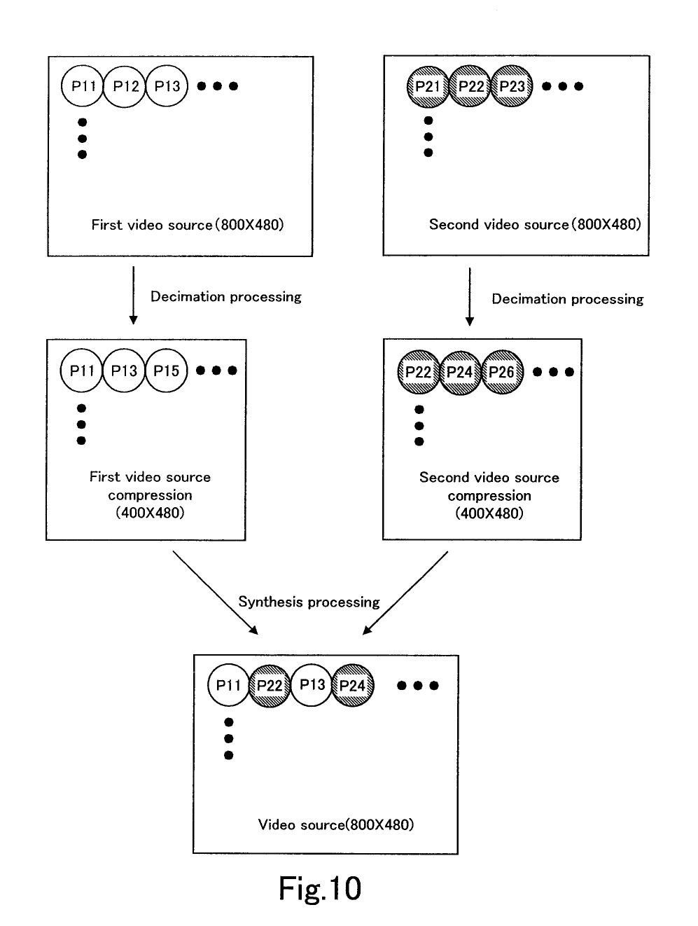

For example, this can be implemented by decimating the pixels on the odd-numbered lines from the video source signals on the driver's seat and decimating the pixels on the even-numbered lines from the video source signals on the passenger seat, as shown in FIG. 10.

However, a video displayed on the display portion 7 on the basis of the video signals obtained by this simple decimation processing lacks the high-frequency component of the original image and lacks continuity of data between adjacent pixels, thus providing a considerably disfigured view.

In view of this, in the present invention, for each of the color components R, G, and B of a plurality of adjacent pixels aligned in a predetermined direction corresponding to a video source signal, the display control portion 5 is configured to generate a new color component for each color component in order to generate a video signal on the basis of a new pixel composed of the newly generated color components.

The present invention cheaply configures a display device capable of preventing loss of high-frequency component while at the same time securing continuity of pixel data. This will be described in detail later.

FIG. 5 is a circuit diagram schematically illustrating a TFT substrate. Reference numeral 111 denotes a display panel driving portion, 112 denotes a scan line driving circuit, 113 denotes a data line driving circuit, 114 denotes a TFT element, 115-118 denote data lines, 119-121 denote scan lines, 122 denotes a pixel electrode, and 123 denotes a sub-pixel.

Referring to FIG. 5, a plurality of sub-pixels 123 are formed with each of the regions defined by the data lines 115-118 and the scan lines 119-121 acting as one unit. Each sub-pixel has formed therein a pixel electrode 122 for applying voltage to the liquid crystal layer 105 and a TFT element 114 for carrying out switching control of the pixel electrode 122.

The display panel driving portion 111 controls the driving timing of the scan line driving circuit 112 and the data line driving circuit 113. The scan line driving circuit 112 carries out selective scanning of the TFT element 114, and the data line driving circuit 113 controls voltage applied to the pixel electrode 122.

On the basis of synthesis data of first image data and second image data or on the basis of individual pieces of the first and second image data, the plurality of sub-pixels form a first image data group for displaying the first image data and a second image data group for displaying the second image data by, for example, transmitting first pixel data (for left side image display) to the data lines 115 and 117 and second pixel data (for right side image display) to the data lines 116 and 118.

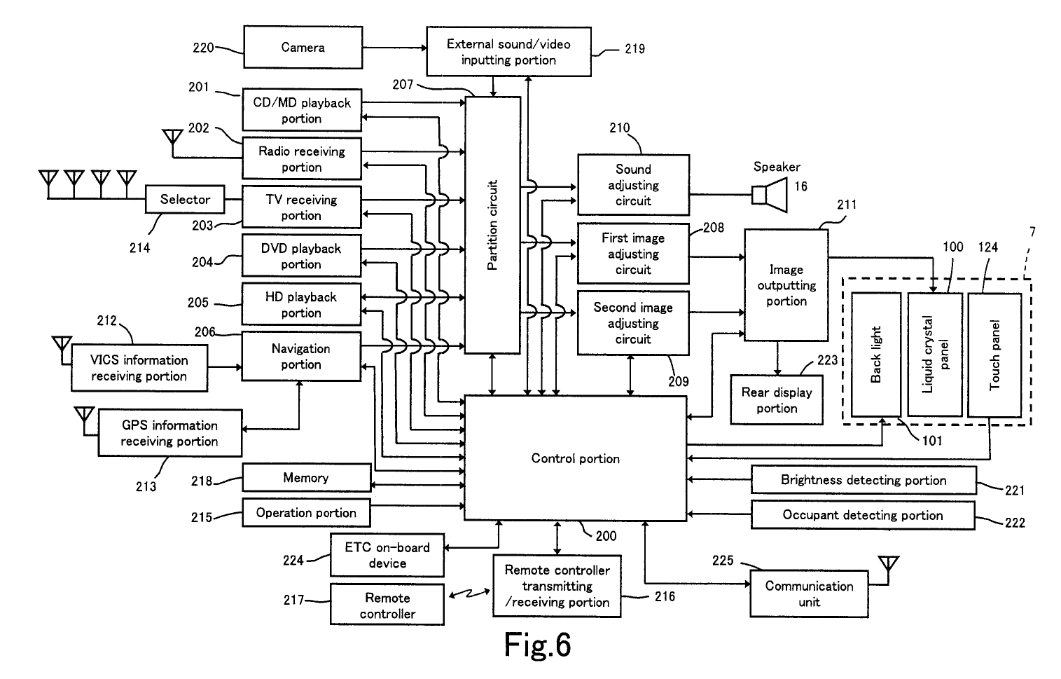

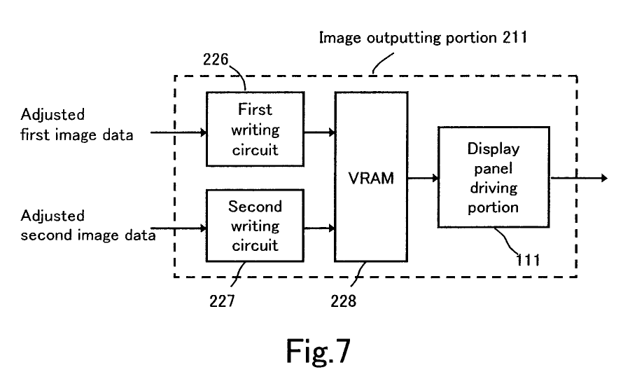

FIG. 6 is a block diagram schematically illustrating the display device according to the present invention, showing an example of application of the display device to what is called an Audio Visual Navigation composite device.

In the figure, the reference numeral 124 denotes a touch panel, 200 denotes a control portion, 201 denotes a CD/MD playback portion, 202 denotes a radio receiving portion, 203 denotes a TV receiving portion, 204 denotes a DVD playback portion, 205 denotes a HD (Hard Disk) playback portion, 206 denotes a navigation portion, 207 denotes a partition circuit, 208 denotes a first image adjusting circuit, 209 denotes a second image adjusting circuit, 210 denotes a sound adjusting circuit, 211 denotes an image outputting portion, 212 denotes a VICS information receiving portion, 213 denotes a GPS information receiving portion, 214 denotes a selector, 215 denotes an operation portion, 216 denotes a remote controller transmitting/receiving portion, 217 denotes a remote controller, 218 denotes a memory, 219 denotes an external sound/video inputting portion, 220 denotes a camera, 221 denotes a brightness detecting portion, 222 denotes an occupant detecting portion, 223 denotes a rear display portion, 224 denotes an ETC on-board device, and 225 denotes a communication unit.

The display portion 7 includes the touch panel 124, the liquid crystal panel 100, and the back light 101. As described above, the liquid crystal panel 100 of the display portion 7 is capable of substantially simultaneously displaying an image seen from the driver's seat side as the first viewing direction and an image seen from the passenger seat side as the second viewing direction.

It should be noted that the display portion 7 may be any of other flat panel displays than the liquid crystal panel, examples including an organic EL display panel, a plasma display panel, and a cold cathode flat panel display.

Source signals supplied from various sources such as the CD/MD playback portion 201, the radio receiving portion 202, the TV receiving portion 203, the DVD playback portion 204, the HD playback portion 205, and the navigation portion 206 are parted through the partition circuit 207 to the first image adjusting circuit 208 or the second image adjusting circuit 209 and to the sound adjusting circuit 210.

The control portion 200 controls the partition circuit 207 in order to part, from the source signals, a video source signal designated for left side display to the first image adjusting circuit 208, part a video source signal designated for right side display to the second image adjusting circuit 209, and part sound signals to the sound adjusting circuit 210.

The first and second image adjusting circuits 208 and 209 use respective parted video source signals to generate video signals that match the display portion 7, and adjust the brightness, color tone, contrast, and the like of the video signals. The video signals adjusted at the first and second image adjusting circuits 208 and 209 are synthesized at the image outputting portion 211, and the synthesized video signal is output to the display portion 7.

The sound adjusting circuit 210 adjusts partition to the speakers, sound volume, and a sound, and the adjusted sound is output to the speakers 16.

The control portion 200 controls the first image adjusting circuit 208, the second image adjusting circuit 209, and the image outputting portion 211 in order to generate a new color component for each of the color components R, G, and B of a plurality of adjacent pixels aligned in a predetermined direction, among the constituent pixels of 1 frame corresponding to a video source signal that is from the partition circuit 207, and to generate a video signal on the basis of a new pixel composed of the newly generated color components.

FIG. 7 is a block diagram schematically illustrating the image outputting portion 211. The image outputting portion 211 includes a first writing circuit 226, a second writing circuit 227, a VRAM (Video RAM) 228, and the display panel driving portion 111.

The first writing circuit 226 writes image data adjusted at the first image adjusting circuit 208 (i.e., image data for the first display image 8 shown in FIG. 1) in a predetermined area of the VRAM 228 (e.g., an area corresponding to a pixel on an odd-numbered line of the display portion 7). The second writing circuit 227 writes image data adjusted at the second image adjusting circuit 209 (i.e., image data for the second display image 9 shown in FIG. 1) in a predetermined area of the VRAM 228 (e.g., an area corresponding to a pixel on an even-numbered line of the display portion 7).

The display panel driving portion 111 is a circuit for driving the liquid crystal panel 100, and, on the basis of the image data (synthesized data of the first image data and the second image data) held in the VRAM 228, drives a corresponding pixel of the liquid crystal panel 100.

In the VRAM 228, writing of image data is carried out so as to correspond to a dual-view display image resulting from synthesizing the first image data and the second image data. This only requires a single driving circuit, and the operation thereof is the same as that of a driving circuit of a usual liquid crystal device.

As another configuration of the image outputting portion 211, instead of synthesizing the first image data and the second image data on the VRAM, such a configuration is contemplated that a first display panel driving circuit and a second display panel driving circuit are provided for driving corresponding pixels of the liquid crystal display panel on the basis of the first image data and the second image data, respectively.

Here description will be made of an example of the various sources shown in FIG. 6. The HD playback portion 205 reads music data such as an MP3 file, image data such as a JPEG file, and the like that are stored in a hard disc (HD), and outputs the data to the partition circuit 207.

When, for example, image data is selected through a menu screen displayed on the display portion 7 for selecting contents such as music data, then corresponding image data is displayed.

The navigation portion 206 includes a map information storing portion that stores map information used for navigation, creates an image for navigation on the basis of the map information and information input through the VICS information receiving portion 212 and the GPS information receiving portion 213, and outputs the image to the partition circuit 207.

The TV receiving portion 203 receives an analogue TV broadcast wave and a digital TV broadcast wave from an antenna through the selector 214, and outputs video source signals of the waves to the partition circuit 207.

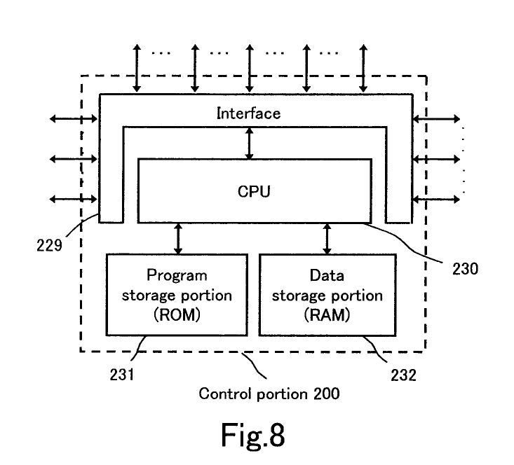

FIG. 8 is a block diagram schematically illustrating the control portion 200. The control portion 200 is composed of a microprocessor and so forth, and includes a CPU 230 for generally controlling the parts and circuits of the display device through an interface 229, a program storage portion 231 of ROM that holds various programs necessary for the operation of the display device, and a data storage portion 232 of RAM that holds various pieces of data.

It should be noted that the CPU 230, the ROM, the RAM, and the like may be configured integrally in a single package or configured separately. Additionally, the ROM may be an electrically rewritable nonvolatile memory such as a flash memory.

The control portion 200 generally controls the entire system. Specifically, the control portion 200 displays on the display portion 7 the operation menu screen for controlling the above-described various sources while at the same time controlling the various sources and the partition circuit 207 in response to an operation input from a user through the operation menu screen in order to carry out control to output to the display portion 7 images corresponding to video sources output from the various sources. Additionally, the control portion 200 controls through the sound adjusting circuit 210 the volumes and the like of the plurality of speakers 16 located in the vehicle in the manner shown in FIG. 2.

When the user selects a single view mode, the control portion 200 outputs to the display portion 7 an image corresponding to a video source signal from a single source selected at this time. When the user selects a dual view mode, the control portion 200 outputs to the display portion 7 images corresponding to video source signals from two sources selected at this time.

In addition to the operation of the operation menu screen of the display portion 7 on which the touch panel 124 is arranged, the user can carry out various other input operations through switches arranged around the display portion 7, an operation portion 215 having a sound recognition circuit, or a remote controller 217 and a remote controller transmitting/receiving portion 216.

Additionally, the display device includes a memory 218 that stores various pieces of setting information such as image quality setting information, programs, and vehicle information, and the control portion 200 controls the image quality and the like of the image displayed on the display portion 7 on the basis of information stored in the memory 218.

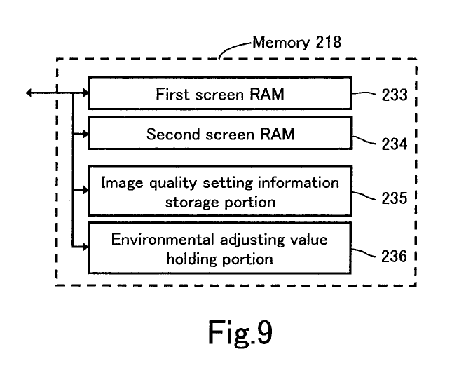

FIG. 9 is a block diagram schematically illustrating the memory 218. In the figure, reference numeral 233 denotes a first screen RAM, reference numeral 234 denotes a second screen RAM, reference numeral 235 denotes an image quality setting information storage portion, and reference numeral 236 denotes an environmental adjusting value holding portion.

Referring to FIG. 9, the memory 218 includes the first screen RAM 233 and the second screen RAM 234 to which image quality adjustment values set by the user for the first video and the second video, respectively, can be written.

Additionally, the memory 218 includes, for image quality adjustment for the first video and the second video, an image quality setting information storage portion 235 that stores in advance a plurality of levels of image quality adjustment values as preset values.

Moreover, the memory 218 includes an environmental adjusting value holding portion 236 that holds image quality adjustment values for the first video and the second video with respect to a surrounding environment in order to adjust the image quality in response to changes in the surrounding environment such as a change in brightness outside the vehicle.

The image quality setting information storage portion 235 and the environmental adjusting value holding portion 236 are each composed of an electrically rewritable nonvolatile memory such as a flash memory or a volatile memory backed up by a battery.

It is possible to display on the display portion 7 an image from, for example, a camera 220 for rear side monitoring connected to an external sound/video inputting portion 219. It should be noted that other than the camera 220 for rear side monitoring, a video camera, a game machine, and the like may be connected to the external sound/video inputting portion 219.

The control portion 200 is capable of changing the setting of a sound localization position and the like on the basis of information detected by a brightness detecting portion 221 (composed of, for example, a vehicle light switch and a light sensor) and an occupant detecting portion 222 (composed of, for example, a pressure-sensitive sensor located at the driver's seat and the passenger seat).

Reference numeral 223 denotes a rear display portion that is provided for rear seats of the vehicle and capable of displaying, through the image outputting portion 211, the same image as the image displayed on the display portion 7 or either the image for the driver's seat or the image for the passenger seat.

Additionally, the control portion 200 causes a toll and the like to be displayed from the ETC on-board device 250. Moreover, the control portion 200 may control the communication unit 225 for having a wireless connection with a mobile phone and the like in order to display information related to the communication unit 225.

The following description details the display device and the display method according to the present invention, which are capable of preventing loss of high-frequency component during generation of a video signal from a source signal while at the same time securing continuity of pixel data.

The control portion 200 controls the first image adjusting circuit 208, the second image adjusting circuit 209, and the image outputting portion 211 in order to generate, from a video source signal, video signals for outputting to the display portion 7 image data that is compression-processed at a predetermined compression rate on a frame basis.

That is, the control portion 200, the first image adjusting circuit 208, the second image adjusting circuit 209, and the image outputting portion 211 constitute the video signal generating portion according to the present invention.

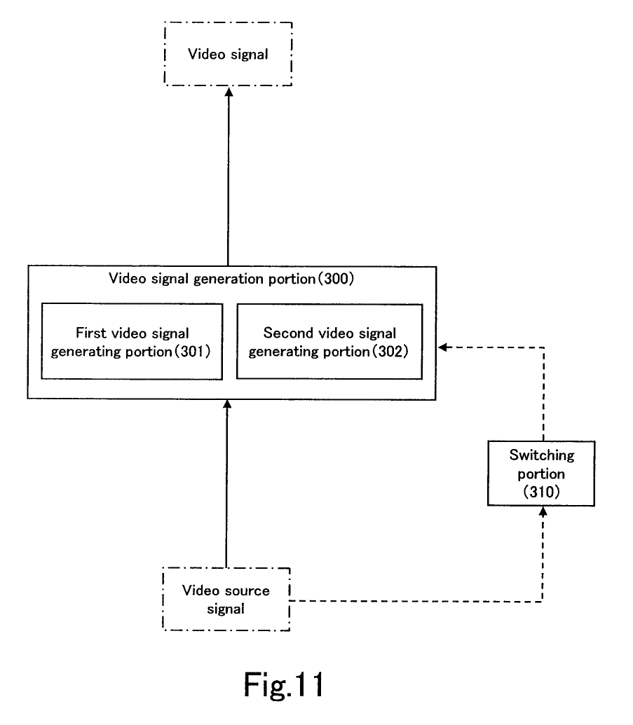

Referring to FIG. 11, a video signal generating portion 300 includes a first video signal generating portion 301 and a second video signal generating portion 302. The video signal generating portions 301 and 302 are respectively located in the first image adjusting circuit 208 and the second image adjusting circuit 209.

The video signal generating portions 301 and 302 use color components R, G, and B of a plurality of adjacent pixels aligned in the horizontal direction and corresponding to a video source signal to generate a new color component for each of the color components R, G, and B in order to generate a video signal on the basis of a new pixel composed of the newly generated color components.

The first video signal generating portion 301 selects a different pixel for each color component from a plurality of color components R, G, and B corresponding to a plurality of adjacent pixels aligned in a predetermined direction, among the constituent pixels of 1 frame corresponding to the video source signal, and extracts a color component of the selected pixel, thus generating new color components R, G, and B.

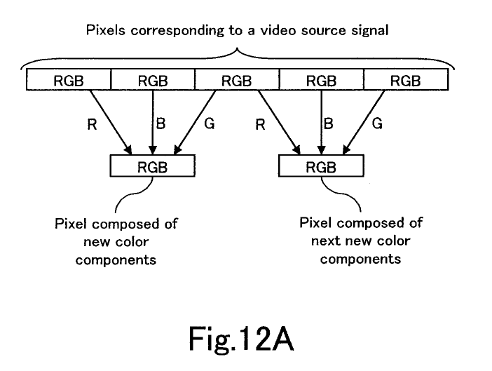

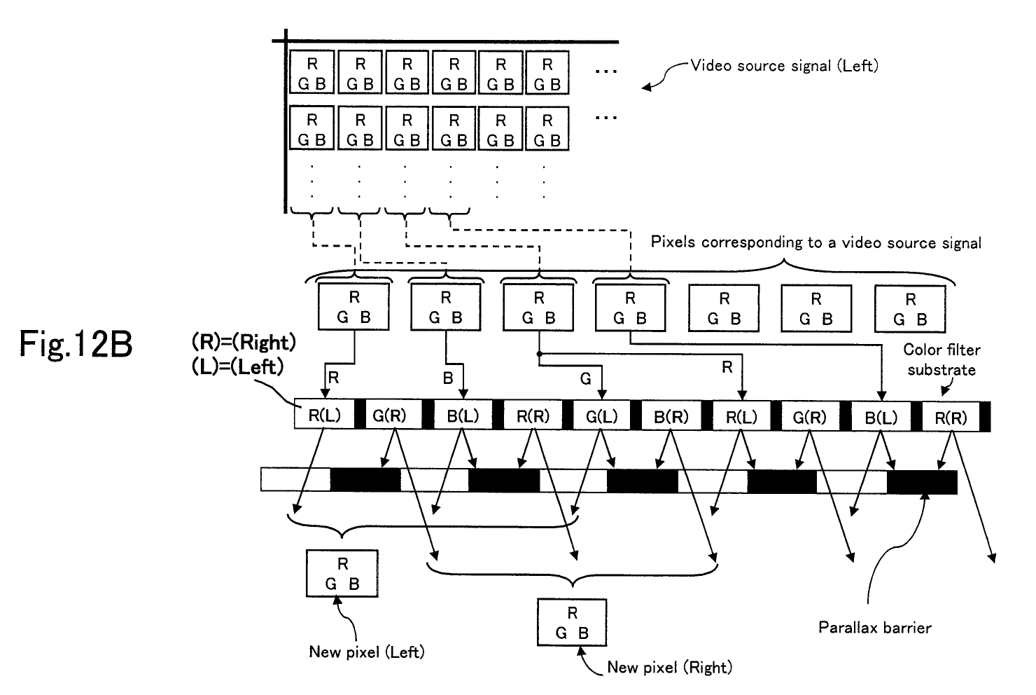

Specifically, referring to FIGS. 12A and 12B, the first video signal generating portion 301 uses, among the constituent pixels of 1 frame corresponding to the video source signal designated for driver's seat side (right) display or passenger seat side (left) display, a group of three adjacent pixels aligned in the horizontal direction and composed of any pixel of attention and two adjacent pixels to the right and left of the pixel of attention to extract an R component from a first pixel, a B component from a second pixel, and a G component from a third pixel, and generate a new pixel composed of the extracted color components R, G, and B.

The first video signal generating portion 301 repeats the above-described processing to, among all of a plurality of original pixels aligned in the horizontal direction, groups of adjacent pixels with one out of every two pixels selected as a pixel of attention. As a result, with a 1-frame image of aligned new pixels, a video signal of the original image compressed into half in the horizontal direction is generated.

Referring to FIG. 12, a look at the original pixels on a color component, R, G, and B, basis shows that the first video signal generating portion 301 extracts the same color components from every two pixels of the original pixels aligned in the horizontal direction.

The new pixel generated by the first video signal generating portion 301 contains at least color components R, G, and B each from a different one of three adjacent pixels selected from a plurality of pixels aligned in the horizontal direction among the pixels constituting 1 frame of a video source signal.

Thus, the compressed pixel data suitably contains the high-frequency component of the video source signal while at the same time pixel continuity is secured.

The second video signal generating portion 302 average-processes a plurality of color components R, G, and B on a color component basis corresponding to a plurality of adjacent pixels aligned in a predetermined direction among the constituent pixels of 1 frame constituting a video source signal, thereby generating new color components R, G, and B.

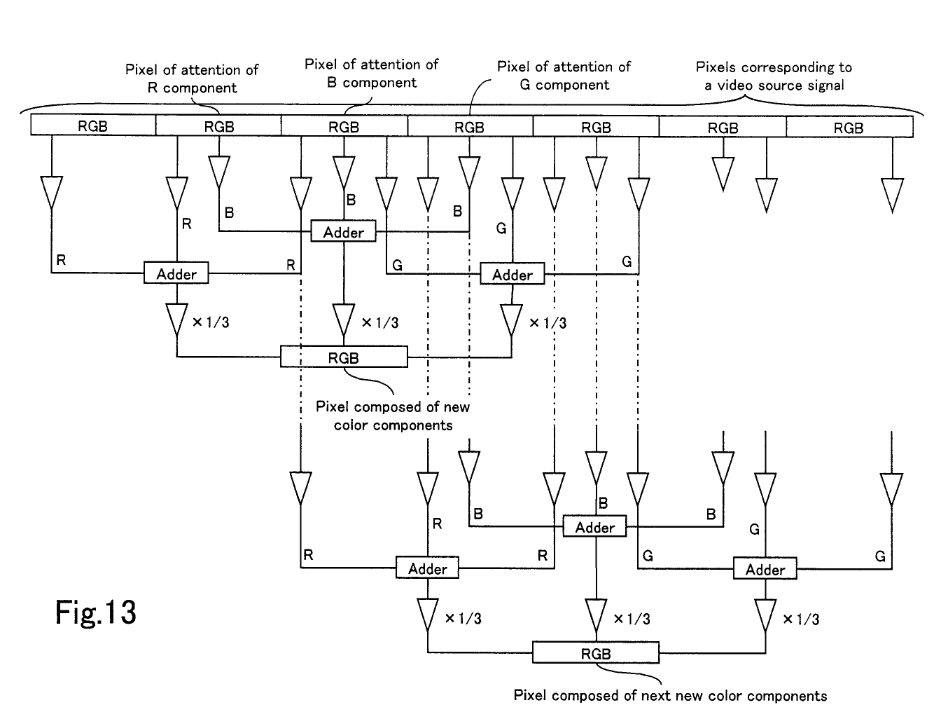

Specifically, referring to FIG. 13, the second video signal generating portion 302 uses, among a plurality of pixels aligned in the horizontal direction among the constituent pixels of 1 frame constituting the video source signal designated for driver's seat side (right) display or passenger seat side (left) display, a group of three adjacent pixels composed of a pixel of attention for R component generation and two adjacent pixels to the right and left of the pixel of attention to extract three R components from which to calculate an average value.

From a group of three adjacent pixels composed of a pixel of attention for B component generation located to the right of the pixel of attention for R component generation and two adjacent pixels to the right and left of the pixel of attention for B component generation, the second video signal generating portion 302 extracts three B components from which to calculate an average value.

Additionally, from a group of three adjacent pixels composed of a pixel of attention for G component generation located to the right of the pixel of attention for B component generation and two adjacent pixels to the right and left of the pixel of attention for G component generation, the second video signal generating portion 302 extracts three G components from which to calculate an average value.

The second video signal generating portion 302 generates a new pixel composed of the calculated average values of R, G, and B as color components.

Additionally, the second video signal generating portion 302 selects a pixel of attention for R component generation, a pixel of attention for B component generation, and a pixel of attention for G component generation every two pixels along the pixel alignment direction, and calculates an average value of R components, an average value of B components, and an average value of G components from respective adjacent pixel groups. Then the second video signal generating portion 302 generates a new pixel composed of the calculated average values of R, G, and B as color components.

The second video signal generating portion 302 repeats the above-described processing to all of a plurality of original pixels aligned in the horizontal direction. As a result, with a 1-frame image of aligned new pixels, a video signal of the original image compressed into half in the horizontal direction is generated.

The color components of the new pixel generated by the second video signal generating portion 302 are at least average values of color components R, G, and B of three adjacent pixels selected from a plurality of pixels aligned in the horizontal direction among the pixels constituting 1 frame of a video source signal.

Thus, the compressed pixel data suitably contains the high-frequency component of the video source signal while at the same time pixel continuity is secured.

In the above-described example, description is made of the case where the adjacent pixel group whose color components are average-processed by the second video signal generating portion 302 varies on a color component basis, that is, the case where the pixel of attention for R component generation, the pixel of attention for B component generation, and the pixel of attention for G component generation differ from each other. It is also possible to use a single pixel from which to select the pixel of attention for R component generation, the pixel of attention for B component generation, and the pixel of attention for G component generation, and with which to constitute an adjacent pixel group.

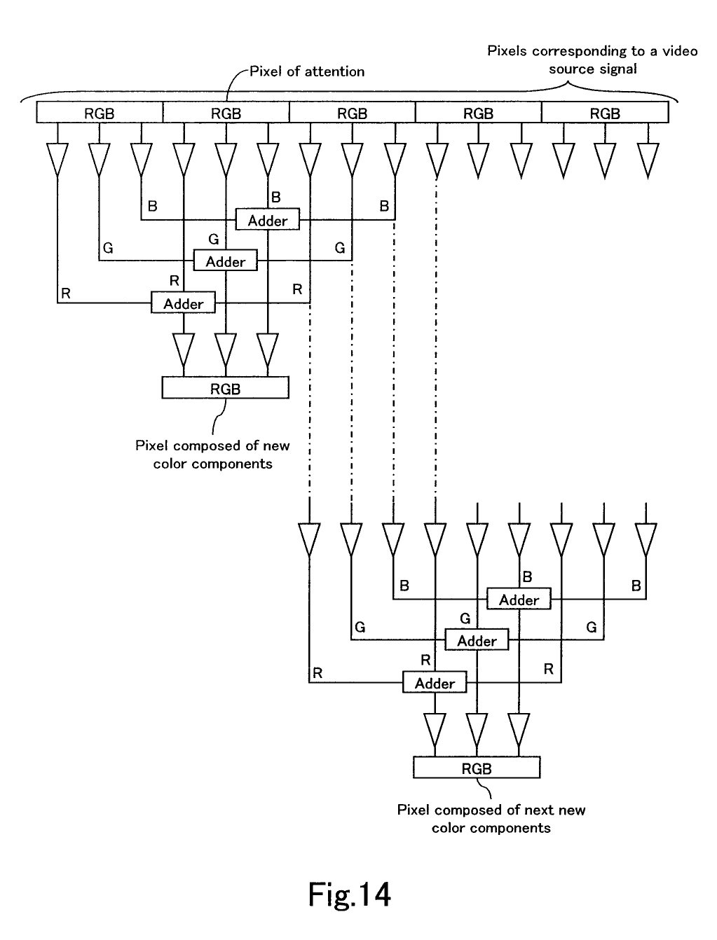

That is, referring to FIG. 14, the second video signal generating portion 302 may be configured to generate a new pixel composed of, as color components, average values of the color components R, G, and B of the identical adjacent pixel group.

In this case, the second video signal generating portion 302 repeats the above-described processing to, among all of a plurality of original pixels aligned in the horizontal direction, groups of adjacent pixels with one out of every two pixels selected as a pixel of attention.

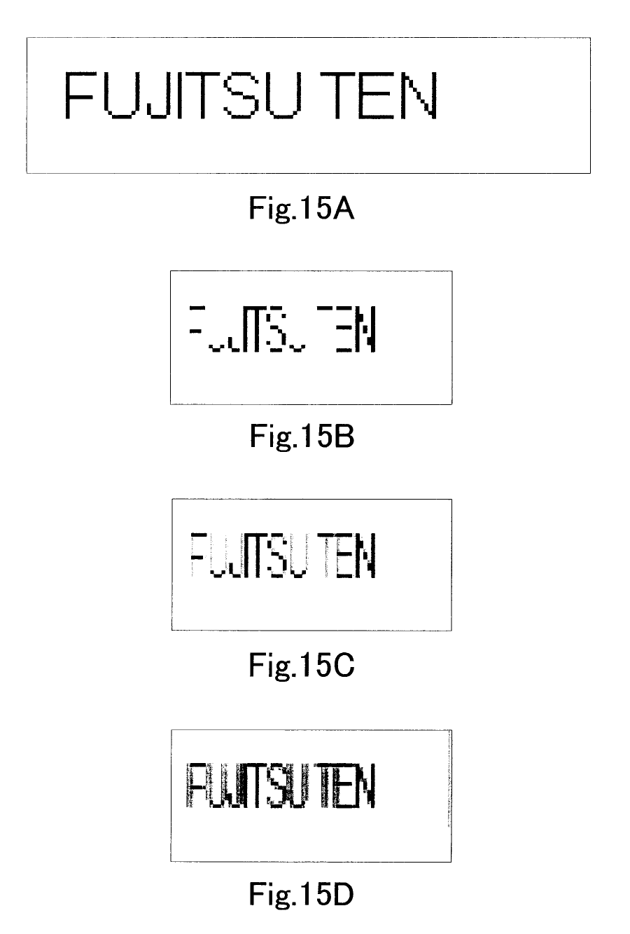

In the case where the video source signal is an image of characters drawn in black against a white background as shown in FIG. 15A, when the video signal displayed on the display portion 7 is generated by simply decimating every two pixels aligned in the horizontal direction, the image has poor legibility of the black characters as shown in FIG. 15B because of loss of high-frequency component and of continuity of adjacent pixels.

However, when a video signal generated by the first video signal generating portion 301 is displayed on the display portion 7, loss of high-frequency component of the original pixels is reduced as shown in FIG. 15C. Although a color component that was originally non-existent occurs in the black characters, the legibility of the characters is maintained.

When a video signal generated by the second video signal generating portion 302 is displayed on the display portion 7, loss of high-frequency component of the original pixels is reduced as shown in FIG. 15D. The black characters are reproduced substantially in black while at the same time the shapes of the characters are maintained.

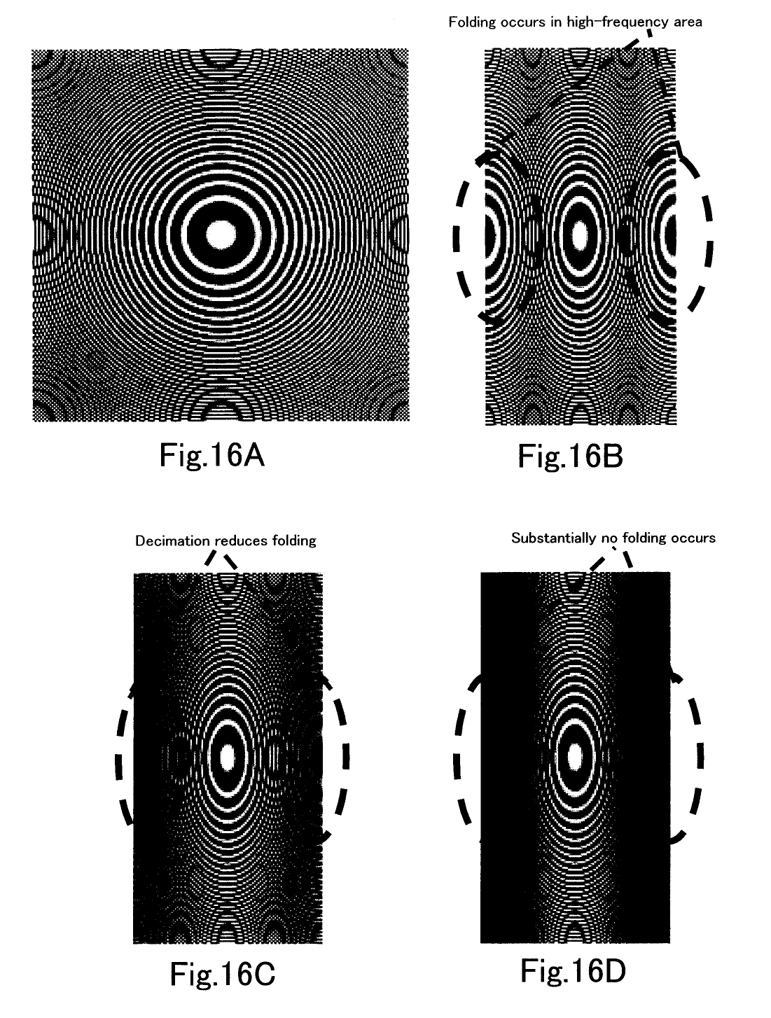

Referring to FIG. 16A, in the case where the video source signal is an image of multiple layers of black concentric circles drawn against a white background with the widths and intervals diminishing in the outward direction from the center, when the video signal displayed on the display portion 7 is generated by simply decimating every two pixels aligned in the horizontal direction, then the image is as shown in FIG. 16B, where the high-frequency component is lost from the image and a “folding” phenomenon occurs, with the result that in high-frequency areas outside the concentric circles, concentric circles that were non-existent appear as noise.

However, when a video signal generated by the first video signal generating portion 301 is displayed on the display portion 7, loss of high-frequency component of the original pixels is reduced as shown in FIG. 16C, where the “folding” is reduced.

When a video signal generated by the second video signal generating portion 302 is displayed on the display portion 7, loss of high-frequency component of the original pixels is reduced as shown in FIG. 16D, where substantially no “folding” occurs.

That is, the present invention maintains image correlation in the horizontal direction to a degree, thereby enabling it to display a natural image. Additionally, the first video signal generating portion 301 can be cheaply configured with a simple filter circuit for extracting a predetermined color component from an adjacent pixel group. The second video signal generating portion 302 can be cheaply configured with a simple low-pass filter circuit for calculating an average value of predetermined color components from an adjacent pixel group.

Referring to FIGS. 15C, 15D, 16C, and 16D, a comparison between the image displayed on the display portion 7 by the video signal generated by the first video signal generating portion 301 and the image displayed on the display portion 7 by the video signal generated by the second video signal generating portion 302 shows that the images have mutually different characteristics.

The first video signal generating portion 301 is suitably used for text images and still images that are monotonous and not colorful such as images of text broadcasting and map images from the navigation portion 206. The second video signal generating portion 302 is suitably used for moving images such as reproduced images of the DVD playback portion 204 and for full color still images.

In view of this, the control portion 200 is configured to switch activation between the first video signal generating portion 301 and the second video signal generating portion 302 by judging image properties such as whether the video source signal is a still image or a moving image so that an image suitable for the video source signal is displayed on the display portion 7. That is, the control portion 200 functions as a switching portion 310 of the display device according to the present invention.

The control portion 200 is capable of judging image properties on the basis of information added to the video signal such as text information and station selecting information. Additionally, the control portion 200 is capable of judging image properties on the basis of various sources including the CD/MD playback portion 201, the radio receiving portion 202, the TV receiving portion 203, the DVD playback portion 204, the HD playback portion 205, and the navigation portion 206, and judging image properties on the basis of operations input from the user through the operation portion 215.

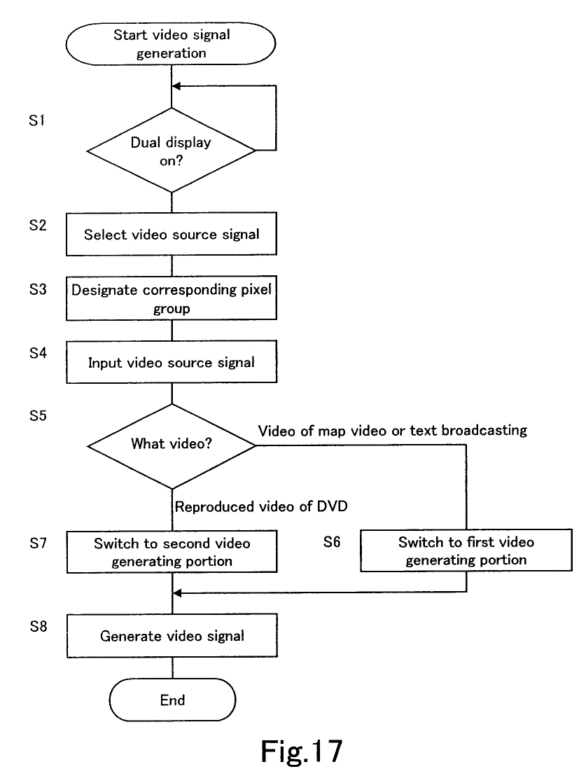

The following describes, by referring to the flowchart shown in FIG. 17, a procedure by which video signals are generated from video source signals, which is necessary when a dual-view display is implemented on the display portion 7.

By an operation through the operation portion 215 or the touch panel 124, “dual view” for displaying two videos on the display portion 7 is turned “ON” (S1). Upon selection of a source to display at the passenger seat side and a source to display at the driver's seat side (S2), the control portion 200 designates pixel groups of the display portion 7 corresponding to the sources (S3), and on the basis of an instruction from the control portion 200, video source signals of the sources are input to the video signal generating portion 300 through the partition circuit 207 (S4).

When a video source is a still image or a nearly still image such as a map video and text broadcasting (S5), the switching portion 310 switches a signal route so that the video source signal is input to the first video signal generating portion 301 (S6), while when a video source is a moving image such as a movie recorded on a DVD or the like (S5), the switching portion 310 switches a signal route so that the video source signal is input to the second video signal generating portion 302 (S7). Then video signals are generated from the video source signals for dual-view display on the display portion 7 (S8).

Other embodiments will be described below. In the above embodiment, description is made of the configuration where the first video signal generating portion 301 or the second video signal generating portion 302 generates color components to constitute a new pixel from an adjacent pixel group composed of three pixels, namely, a pixel of attention at the center and two pixels located to the right and left of the pixel of attention. The number of pixels constituting the adjacent pixel group will not be limited to the above; it is possible to generate color components to constitute a new pixel from an adjacent pixel group composed of five pixels including the pixel of attention and the two pixels located to the right of the pixel of attention and the two pixels located to the left of the pixel of attention. In this case, loss of high-frequency component is prevented and the “folding” is reduced on a more advanced level.

While in the above embodiment description is made of ½ compression processing of 1-frame constituent pixels in the horizontal direction thereof, the compression rate is determined on the basis of the number of constituent pixels of 1 frame of a video source signal and the number of constituent pixels of the display device. For example, selecting a pixel of attention on an every two pixels basis results in a 50% compression rate, selecting a pixel of attention on an every three pixels basis results in a 33% compression rate, and selecting a pixel of attention on an every four pixels basis results in a 25% compression rate.

While description is made of the case where the compression is carried out in the horizontal direction in accordance with the display device that arranges the parallax barriers in the vertical direction and displays different videos in right and left viewing directions, the display device that arranges the parallax barriers in the vertical direction may compress the constituent pixels of 1 frame of a video source signal in the vertical direction.

While in the above embodiment description is made of the case where the video signal generating portion 300 includes the first video signal generating portion 301 and the second video signal generating portion 302, the video signal generating portion 300 may include either the first video signal generating portion 301 or the second video signal generating portion 302.

For example, in the case of a vehicle that includes the navigation portion 206 and does not include the TV receiving portion 203 and the DVD playback portion 204, the vehicle may include only the first video signal generating portion 301.

While in the above embodiment description is made of the case where the present invention is applied to a dual-view display device mounted in a vehicle, the present invention will not be limited to this application but will find applications in household or theater display devices.

While in the above embodiment description is made of the case where the present invention is applied to a dual-view display device that displays different videos in the right and left viewing directions, the present invention can be applied to multi-view displays that display different videos in a plurality of viewing directions such as three viewing directions and four viewing directions. In this case, the first video signal generating portion 301 and/or the second video signal generating portion 302 and peripheral circuits thereof may be provided by a number corresponding to the viewing directions.

The specific configurations of the parts described in the above embodiments may be conveniently modified in design insofar as the advantageous effects of the present invention will be secured.

1. A display device comprising a display portion capable of displaying distinct videos on a common screen in a plurality of viewing directions and a video signal generating portion for generating video signals by carrying out compression processing of video source signals for the viewing directions at predetermined compression rates,
wherein the video signal generating portion generates new color components by using color components of a plurality of adjacent pixels aligned in a predetermined direction among pixels corresponding to the video source signals, and generates each of the video signals on the basis of a new pixel composed of the generated color components.

2. The display device according to claim 1, wherein the video signal generating portion generates the new color components by extracting a different color component from a different pixel among the color components of the plurality of adjacent pixels.

3. The display device according to claim 1, wherein the video signal generating portion generates the new color components by using average values of the color components of the plurality of adjacent pixels, the average values being average-processed on a color component basis.

4. The display device according to claim 3, wherein the video signal generating portion carries out the average-processing by varying groups of adjacent pixels on a color component basis.

5. The display device according to claim 1, wherein the video signal generating portion includes: a first video signal generating portion for generating the new color components by extracting a different color component from a different pixel among the color components of the plurality of adjacent pixels; a second video signal generating portion for generating the new color components by using average values of the color components of the plurality of adjacent pixels, the average values being average-processed on a color component basis; and a switching portion for switching between the first video signal generating portion and the second video signal generating portion.

6. The display device according to claim 5, wherein the switching portion switches between the first video signal generating portion and the second video signal generating portion on the basis of a video source signal.

7. A display method for displaying, on a display portion capable of displaying distinct videos on a common screen in a plurality of viewing directions, video signals generated by carrying out compression processing of video source signals for the viewing directions at predetermined compression rates, the method comprising:
generating new color components by using color components of a plurality of adjacent pixels aligned in a predetermined direction among pixels corresponding to the video source signals; and
generating each of the video signals on the basis of a new pixel composed of the generated color components.
